(19) United States
(12) Patent Application Publication
(10) Pub. No.: US 2011/0115732 A1
(43) Pub. Date: May 19, 2011

(54) MULTIMODE TOUCHSCREEN DEVICE

(75) Inventors: Philippe CONI, SAINT JEAN D'ILLAC (FR); Yves SONTAG, BORDEAUX (FR)

(73) Assignee: THALES, NEUILLY SUR SEINE (FR)

(21) Appl. No.: 12/948,150

(22) Filed: Nov. 17, 2010

(30) Foreign Application Priority Data
Nov. 17, 2009 (FR) 09 05510

(51) Int. Cl. G06F 3/041

(52) U.S. Cl. 345/173

(57) ABSTRACT

The invention provides a touchscreen device including at least one multiplexed touchscreen, control electronics and acquisition and processing electronics, the touchscreen including a first rigid substrate having a plurality of conducting rows, a second flexible substrate having a plurality of conducting columns perpendicular to the rows. The control electronics has a generator of a high-frequency voltage for supplying a first multiplexer for addressing the plurality of conducting rows. The acquisition and processing electronics includes a second multiplexer for addressing the plurality of conducting columns and a synchronous demodulator which operates at the same frequency as the high-frequency voltage generator and delivers a plurality of output voltages on each column and calculation means making it possible to calculate the impedance existing between each output voltage and the input voltage. The acquisition and processing electronics also includes means for analysing the impedance making it possible to calculate its resistive part and its capacitive part.

### CROSS-REFERENCE TO RELATED APPLICATION

This application claims priority to foreign French patent application No. FR 09 05510, filed on Nov. 17, 2009, the disclosure of which is incorporated by reference in its entirety.

### FIELD OF THE INVENTION

The field of the invention is that of touchscreens. These screens are sensitive surfaces activated by a user's finger or hand and usually make it possible to control an item of equipment or a system through a graphical interface. A large number of possible uses exist in fields such as computing, telecommunications or aeronautics. For the latter field, mention will be made, in particular, of aircraft piloting. A pilot can thus check and control all of the functions displayed by the aircraft's instrument panel viewing devices.

### BACKGROUND OF THE INVENTION

An ideal touch-sensitive system must be capable of managing the movement of one or more cursors by stroking and of managing the presses of one or more keys. It must be robust to failures and be able to operate, in degraded mode, on at least one mode. For aeronautical applications, the right-hand/left-hand information or Pilot/Copilot information must be available to make secure and hierarchize the presses. Moreover, the system must make it possible to associate with each press a load along the axis normal to the surface of the touchscreen, as well as the determination of the direction of the press.

Various “touchscreen” technologies exist, the two main ones being capacitive touch-sensitive surfaces and resistive touch-sensitive surfaces. Projected capacitive touch-sensitive surfaces operate by acquisition of a modification of electrical capacitance when the user's finger approaches the touch-sensitive surface. Lightweight contact is sufficient, allowing the movement of one or more cursors, but these touch-sensitive surfaces do not operate with a glove or just any stylus. Moreover, validation conditional on a pressing load is not possible. By way of example, PCT application WO 2004/061808 describes a touch-sensitive sensor of this type.

Resistive touch-sensitive surfaces make it possible, to some extent, to check the pressing force, to operate with gloves and any stylus. On the other hand, the movement of a cursor by simple stroking is no longer possible.

To alleviate these drawbacks, various technical solutions have been proposed. For example, U.S. Pat. No. 6,492,979 describes a secure “touchscreen” coupled to strain gauges and to capacitive electrodes, making it possible to provide information about the load applied, but this device cannot discern multiple presses. Patent GB 2 453 403 thus describes a multiplexed capacitive touch-sensitive system comprising low-pass filters so as to reduce the sensitivity to electromagnetic disturbances. Patent EP 2 009 542 describes a touchscreen comprising two measurement devices consisting of two stages of infrared diodes allowing the redundancy of the system, but this double stage of sensors cannot discern a press from simple stroking.

Finally, patents FR 2 925 714 and FR 2 925 717 from the company Stantum describe various types of multicontact touch-sensitive sensors. These sensors associate capacitive measurement and resistive measurement. As seen in FIG. 1 extracted from patent FR 2 925 714, the touch-sensitive sensor 1 is disposed on a viewing screen 2 linked by electronic interfaces 3 to a main processor 4 and a graphical processor 5. This sensor comprises a multicontact passive matrix comprising means of electrical power supply to one of the two axes of the matrix and means for detecting electrical characteristics along the other axis of the matrix, at the intersections between the two axes, the measured characteristic being alternately the capacitance and the resistance. However, the alternation of the capacitive and resistive measurements doubles the acquisition time and the presence of two processing chains doubles the cost of the processing electronics.

### SUMMARY OF THE INVENTION

The multimode touchscreen device according to the invention does not exhibit these drawbacks. The principle of the invention consists in having two operating principles coexist in a single processing device, associated with a single substrate capable of operating equally and simultaneously in multiplexed resistive and projected capacitive mode. The touch-sensitive sensor according to the invention thus modulates both the capacitance information and the resistance information on the same signal making it possible to simultaneously obtain these two items of information without latency. This device thus allows a “dual” operating mode by stroking and by activation while requiring only simple adaptations of contemporary devices to the extent that the core of the device resides essentially in the touchpad's drive and processing electronics and not in the touchpad itself.

More precisely, the subject of the invention is a touchscreen device comprising at least one multiplexed touchscreen, control electronics and acquisition and processing electronics, the touchscreen comprising a first rigid substrate comprising a plurality of conducting rows, a second flexible substrate comprising a plurality of conducting columns perpendicular to the said rows, the control electronics comprising a first multiplexer addressing the plurality of conducting rows, the acquisition and processing electronics comprising a second multiplexer addressing the plurality of conducting columns, characterized in that the control electronics comprises a generator of a high-frequency voltage supplying the first multiplexer in such a way that each row is subjected to an input voltage, the acquisition and processing electronics comprises a synchronous demodulator operating at the same frequency as the high-frequency voltage generator and delivering a plurality of output voltages on each column and calculation means making it possible to calculate the impedance existing between each output voltage and the input voltage.

Advantageously, the acquisition and processing electronics comprises first storage means making it possible to carry out a mapping of the values of the various impedances over the entirety of the touchscreen in the absence of the hand of a user in the vicinity of the touchscreen and second storage means making it possible to carry out a mapping of the variations of the values of the various impedances over the entirety of the touchscreen in the presence of the hand of a user in the vicinity of the touchscreen. The acquisition and processing electronics can also comprise means for analysing the impedance making it possible to calculate the resistive part and the capacitive part of the said impedance as well as means for recognizing the stroking also called “pull-down” of the touchscreen by a user finger, the said “pull-down” corresponding to a local increase in the said capacitive part of the impedance. Finally, the acquisition and processing electronics can comprise means for recognizing the physical contact also called “pull-up” of the touchscreen by a user finger, the said “pull-up” corresponding to a local decrease in the said resistive part of the impedance, as well as means for calculating the respective barycentres of the various “pull-downs” and various “pull-ups” making it possible, inter alia, to determine whether the user's hand is a right hand or a left hand. The acquisition and processing electronics can also comprise securing or “monitoring” means comprising means for comparing the resistive part and the capacitive part of each impedance with a predetermined value so as to deduce therefrom a possible cutoff of the row or column corresponding to the said impedance. In a first variant, in at least one zone of the touchscreen, the acquisition and processing electronics takes into account only the “pull up” function so as to create a virtual keyboard in the said zone. In a second variant, in at least one zone of the touchscreen, the acquisition and processing electronics takes into account only the “pull-down” function so as to create a touch-sensitive surface of “touch-pad” type in the said zone.

The invention also relates to a viewing device comprising at least one viewing screen and a touchscreen device such as defined previously, this device possibly being an aircraft instrument panel viewing unit intended to be used separately or simultaneously by a pilot and a copilot.

### BRIEF DESCRIPTION OF THE DRAWINGS

The invention will be better understood and other advantages will become apparent on reading the nonlimiting description which follows while referring to the appended figures among which:

FIG. 1, already commented on, represents a touch-sensitive keyboard according to the prior art;

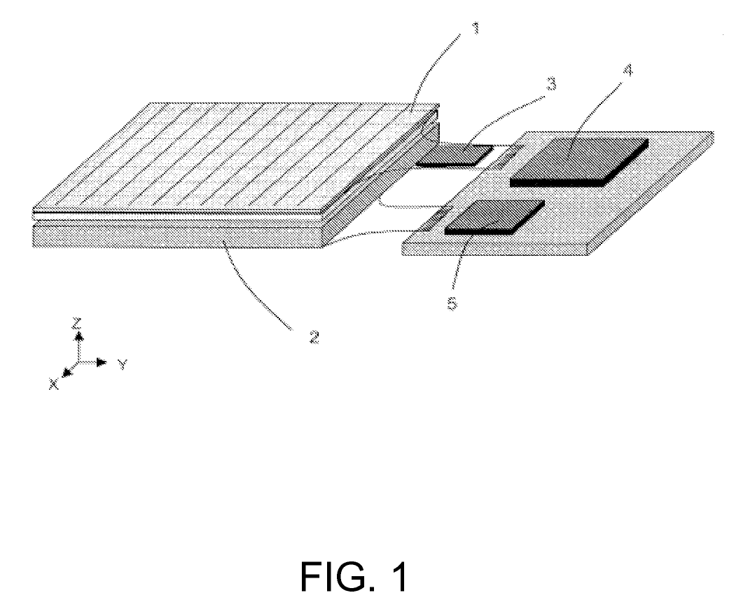

FIG. 2 represents the general principle of a touchscreen according to the invention;

FIG. 3 represents the electronic diagram of a touchscreen device according to the invention;

FIG. 4 represents the electronic diagram of an intersection comprising a row and a column of the said touchscreen device;

FIGS. 5, 6, 7 and 8 represent the variations of the impedance at the level of the said intersection, engendered by the finger or the hand of a user of the said touchscreen in different typical cases; and

FIGS. 9, 10 and 11 represent three modes of use of the touchscreen device according to the invention.

### DETAILED DESCRIPTION

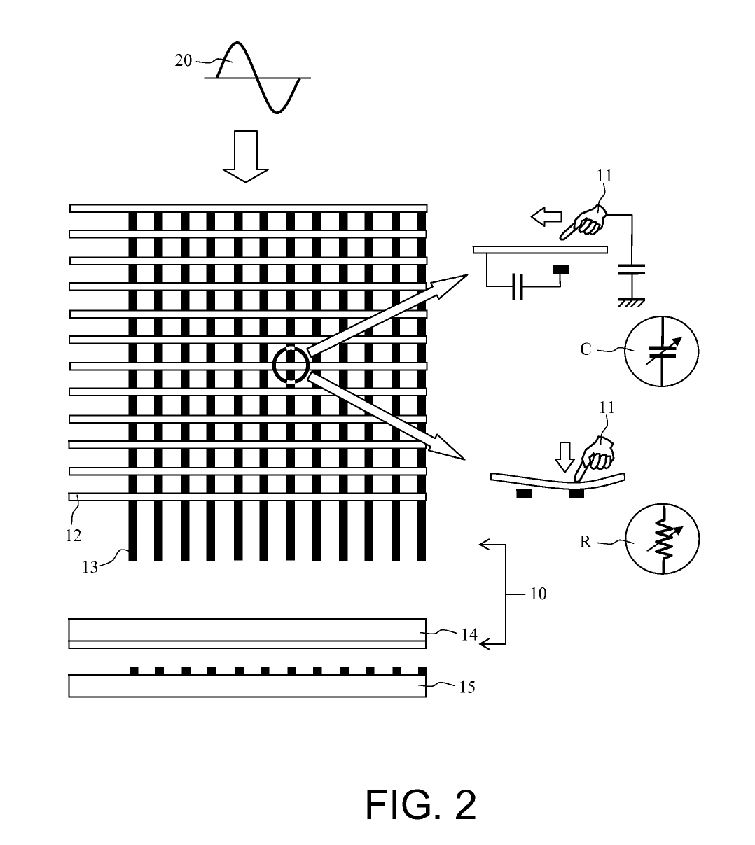

FIG. 2 represents the general principle of a touchscreen device 10 according to the invention. This figure comprises a view from above of the screen, a profile view and on the right side of FIG. 2, two basic diagrams showing the operation of the device depending on whether a user's hand 11 approaches the screen 10 or touches it, so exerting a pressure. As seen in this figure, the device comprises a touchpad 10 which is a multiplexed touch-sensitive surface, composed of rows 12 and columns 13 deposited opposite each other on a flexible substrate 14 and a rigid substrate 15. Such a device naturally operates in resistive mode. When an operator presses on the flexible substrate 14, the local load causes the contact of at least one row and one column, with the node of the press causing a variation in the resistance R of the intersection of this row and of this column that it suffices to measure to obtain the location of the press (diagram at the bottom right of FIG. 2). This type of pad is conventional and manufactured notably by the English company “Danielson”. The core of the invention is to operate this pad in capacitive mode without modifying it. It is known, indeed, that when a user strokes a keyboard, his hand can give rise to variations in the capacitances situated at the intersections of the rows and columns of the touchpad, the rows and the columns naturally having a coupling capacitance. To ensure this function, a generator 20 supplies the pad 10 with sinusoidal high-frequency voltage by way of an injection capacitor. At high frequency, a natural capacitive effect C exists at the intersections of the rows and columns (diagram at the top right of FIG. 2).

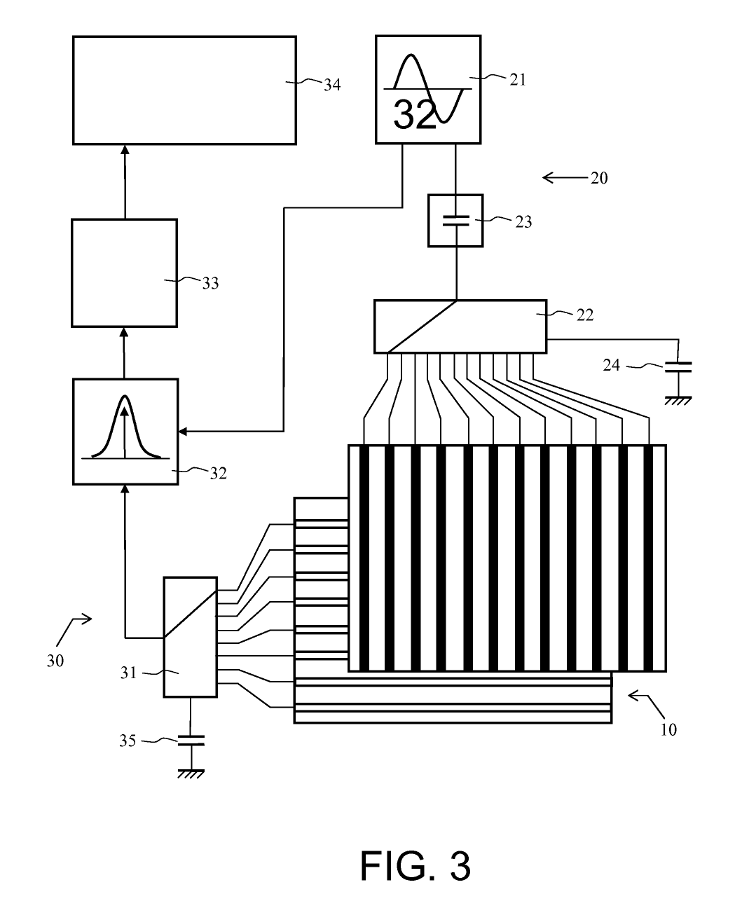

More precisely and by way of nonlimiting example, the whole of the touchscreen device according to the invention is represented in FIG. 3. It comprises:
A touchpad 10 composed of rows and columns as described previously;
Control electronics 20;
Acquisition and processing electronics 30.

The control electronics 20 comprises:
a high-frequency voltage generator 21. The value of the voltage and its frequency depend essentially on the parameters of the grid of rows and columns and the distance separating them;
a first multiplexer 22 addressing the plurality of conducting rows 12 of the touchpad 10 through an injection capacitor 23, the voltage of the input signal being denoted V_{IN}. The multiplexer is not perfect and possesses capacitive losses 24 at the frequency considered.

The acquisition and processing electronics 30 comprises:
a second multiplexer 31 addressing the plurality of conducting columns having capacitive losses 35;
a synchronous demodulator 32 operating at the same frequency as the high-frequency voltage generator 21 and delivering a plurality of output voltages V_{OUT} on each column;
an analogue-digital converter 33 making it possible to convert the analogue signal into a digital signal;
calculation, storage and checking means 34 making it possible to calculate the impedance Z existing between each output voltage and the input voltage, to store it, to determine its resistive and capacitive component, to deduce therefrom the type of action of the user on the touchpad.

The synchronous demodulation performed by the demodulator 32 makes it possible to filter the electromagnetic disturbances termed “EMI” by acting as a bandpass filter with high quality factor, thereby avoiding the use of passive filtering. Moreover, even if the disturbance is at a frequency neighbouring the frequency of the generator 21, it is filtered by virtue of the high selectivity of the filter and of the fact that the disturbance can never be synchronous with the injection frequency. In a complementary manner, it is possible to slightly vary, in a pseudo-random manner, the injection frequency so as never to be disturbed, even by an identical and in-phase frequency.

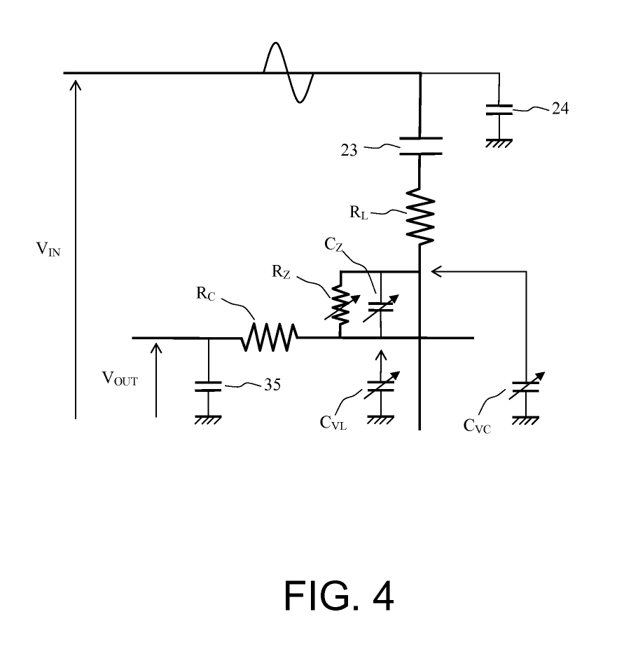

FIG. 4 represents the equivalent electrical diagram of the device for an intersection of a given row and column. The row has an equivalent resistance R_{L}. The generator supplies this row through the injection capacitor 23. In parallel, the first input multiplexer has a capacitance 24. The column has an equivalent resistance R_{C}. In parallel, the second output multiplexer has a capacitance 35. At the intersection of the row and column, the user's hand or finger will cause a variation in the impedance Z having at one and the same time a resistive component R_{Z} and a capacitive component C_{Z}. The conventional relation linking the input voltage and the output voltage is Vout=Z Vin with, in complex form, Z=A+Bj.

The signal is thereafter demodulated by the synchronous demodulator so as to extract therefrom the rms value Vout=Vin*×√(A²+B²).

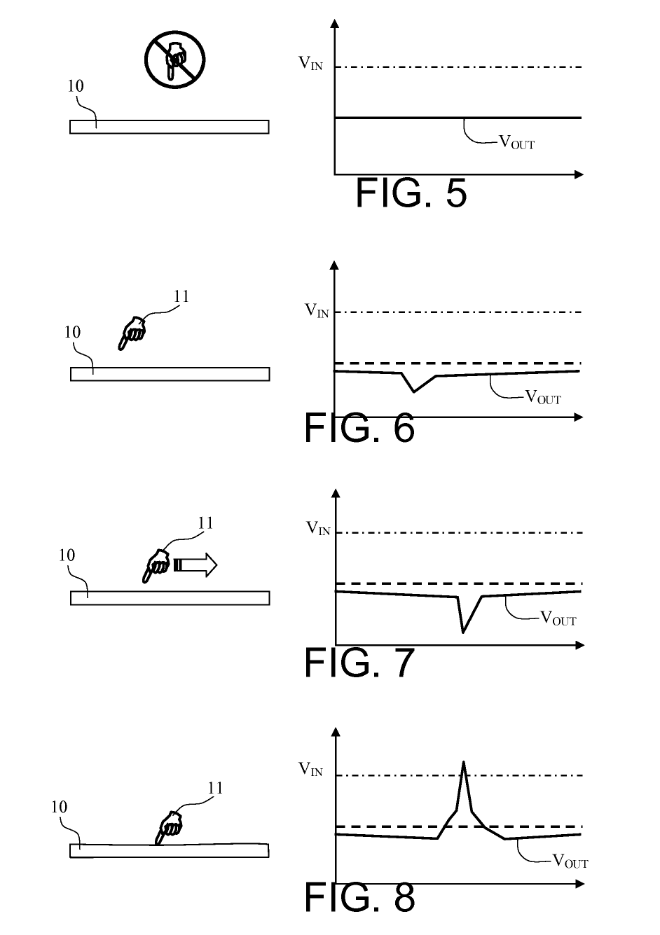

FIGS. 5, 6, 7 and 8 represent the variations of this rms value when the touch-sensitive surface is used. Represented on the left in these figures is the position of the user's hand 11 with respect to the touch-sensitive surface 10 and on the right the graph representing the variation of the corresponding output signal Vout as a function of the position on a row invoked by the user's hand. Also shown on these graphs is the input voltage Vin.

In FIG. 5, the user's hand is distant from the touchpad. The powered row is coupled capacitively to the columns, thereby forming a capacitive divider bridge with the measurement device which possesses a coupling capacitance with respect to earth. The signal obtained is at an intermediate potential between the power supply voltage Vin and earth, the resistance R_{Z} is infinite and the pressing capacitance C_{Z} zero. This signal is, of course, constant over the whole row.

Represented in FIG. 6 is the stroking of the pad by the user's hand. The term stroking is understood to mean the fact that the finger brushes or touches the touchpad without exerting measurable pressure. The finger then projects a capacitance which will couple at the level of the node the row and column to earth causing a local attenuation of the signal as seen on the graph of FIG. 6. The finger acts as a local “pull down”.

In the case of contact without pressure as represented in FIG. 7, the coupling capacitance increases to a threshold and then remains constant. The signal decreases to a minimum. It is thus possible to follow the movement of the finger.

In the case of contact with pressure as represented in FIG. 8, the act of pressing creates, according to the load applied, either a capacitance between the contact point and earth or a contact resistance between rows and columns. In the case of physical contact with pressure, the row/columns capacitive coupling disappears, the resistance R_{Z} decreases and the signal increases. The finger is said to act as a local “pull up”.

Thus, a simple analysis of the signal at a row/column crossover makes it possible very simply to determine:
absence of the hand: the signal is constant;
stroking: the signal decreases locally;
contact: the signal attains a minimum;
contact with pressure: the signal increases.

To give some orders of magnitude, for touchscreens with an area of from one to a few tens of dm², the capacitance variations to be detected are of the order of a few tens of picoFarads and the resistance variations to be detected are of the order of a few tens of Ohms. The detection of variations of this order is conventional and may be achieved by means known to the person skilled in the art.

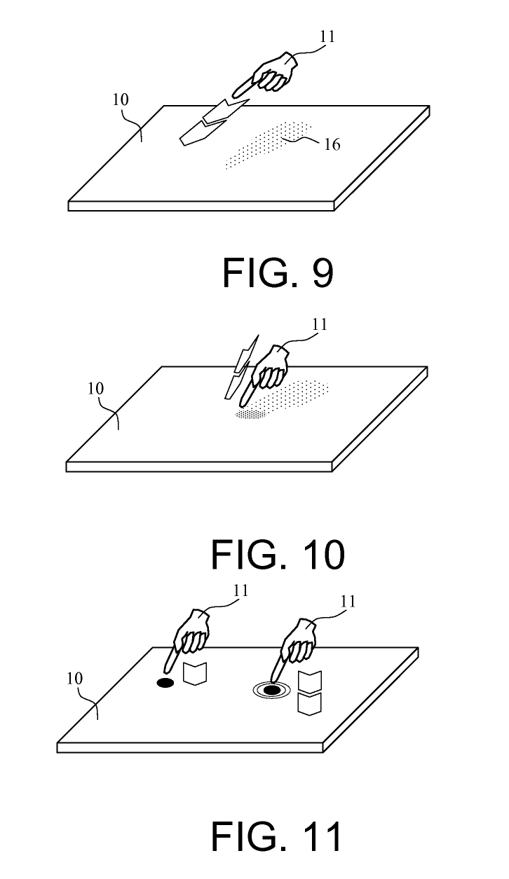

Of course, it is possible to carry out a complete mapping of the signals over the entirety of the matrix of row/column crossovers. It is then possible to define three modes of detection detailed hereinbelow and represented in FIGS. 9, 10 and 11:
FIG. 9: so-called “Projected capacitive” mode making it possible to detect the approach of the hand or finger, as well as its direction of approach. In FIG. 9, the intersections 16 of the pad 10 where the signal is representative of this mode are represented by light hatching;
FIG. 10 so-called “Discrete capacitive” mode making it possible to detect that one or more fingers are stroking the surface, thereby making it possible to ensure multi-cursor management. In FIG. 10, the intersections 16 of the pad 10 where the signal is representative of this mode are represented by dark hatching;
FIG. 11: so-called “Resistive” mode: Onwards of a certain pressure, multiple presses are detected and simultaneous analysis of the contact resistance and the cross section of the press makes it possible to give the pressure information. In FIG. 11, the intersections 16 of the pad 10 where the signal is representative of this mode are represented in black, the variation of the signal makes it possible to determine the intensity of the pressure. Thus, the hand 11 depicted on the right of FIG. 11 is pressing more strongly on the touchpad 10 than the hand 11 depicted on the left of this same figure causing a stronger and more extensive variation in signal.

In the absence of approach of the hand, the touch-sensitive controller of the device can permanently effect an “image” of the signals arising from the pad and deduce therefrom a “table” of signals when quiescent based on sliding average, this table being stored. This image is subtracted from the table of instantaneous values, so as to form the table of deviations, on the basis of which it is possible to ascribe to each point or to each intersection its status.

Such a device is therefore “multitouch” and makes it possible to manage the movement of one or more cursors by stroking in capacitive mode, with the possibility of skimming over buttons without untimely activation. Simple pressure allows the validation of one or more objects, the analysis of the pressing area making it possible to measure the deformation of the finger, and therefore the pressure, thereby giving a third detection axis. It is thus possible to have genuine three-dimensional information on the position of the hand.

Moreover, the projected capacitance at the point of pressing defines a shape which is elongated in the direction of the hand, by capacitive projection of the latter. The barycentre of the capacitive press is therefore shifted from that of the resistive press, this shift forming a vector indicating the direction of the press. It should be noted that this shift of the capacitive press with respect to the real press is normally a defect of capacitive touchpads, which is generally corrected by software. In the present case, this defect is utilized and becomes a functional characteristic. During pressing, the points in physical contact are in “pull up” at the level of the tip of the finger, but the entire finger projects a capacitance, which places the points opposite in “pull down”. Thus, the barycentre assigned the points in “pull up” and the barycentre assigned the points in “pull down” define a vector indicating the direction of pressing.

The knowledge of this vector makes it possible to define new information which is not available on existing “touchscreens” or to carry out new functions. Mention will be made notably of:
Recognition of the right hand or of the left hand of the user or of the direction of pressing;
Rotation of a graphical object by rotation of the finger, utilizing the direction of the vector;
Position and elevation of the finger by utilizing the norm of the vector.

Among the new functions accessible by the touchscreen according to the invention when it is coupled with a graphical screen displaying information, windows or icons of the type of those of the “Windows” software marketed by the company Microsoft, mention will also be made of:
Segregation of cursors and presses

On a conventional touch-sensitive surface, it is not possible to dissociate a cursor from the state of a validated object. Skimming over it with a finger causes its activation. In the device according to the invention, the objects are validated if the signal is in “pull up”. The cursors are managed only in “pull down”. They disappear in the case of signal loss. The validation is active only in “pull up” mode, that is to say when the user presses physically on the screen.

Securing or “Monitoring”

In a conventional matrix resistive “touchscreen”, the loss of a row or column is not detectable, since the “quiescent” state, that is to say in the absence of the user's hand, is at high impedance. The use of an AC current makes it possible to benefit from the capacitive coupling at the levels of the nodes. The quiescent state is thus represented by an intermediate level due to the resistive bridge. Cutoff is easily detectable, by loss of the quiescent signal.

Recognition of the Use of Gloves

The value of “pull down” previous to a press makes it possible to ascertain the operator's capacitance which is different depending on whether the hand is bare or is wearing a glove, thereby making it possible to adjust the thresholds and to adapt the ergonomics of the functions. For example, it is possible to intensify the haptic effect if the user is wearing gloves. This application is particularly beneficial for aeronautical applications.

Creation of Virtual Keyboards or “Touchpads”

A virtual keyboard may be created on the graphical screen. Only the “pull up” function in this zone (resistive mode with pressing pressure) is then used. It is also possible to create a “touchpad” zone. In this case, management is done solely in “pull down” mode with movement by stroking (capacitive mode with stroking)

Creation of Shadow Effects

To the extent that the projected capacitive effect is utilizable, the shadow of the finger or fingers may be overlaid on the symbology on the graphical screen as a function of the zones in “pull down” mode. The shadow effect can have the following function. Within the framework of writing on the screen, the operator is led to place his palm on the screen, this possibly giving rise to the untimely validation of the zones considered, hence the usefulness of blocking out the palm while writing. While writing, the activation is then done in “pull-up” mode without any peripheral effect at the level of the contact (rigid tip of the stylus, with no peripheral capacitive effect), whereas the palm has only a pull-down effect over a wide area. This complex signature comprising point-wise “pull-up” information and area-wise “pull down” information may be used to deactivate the presses in the zone of the palm, and to recognize whether the operator is left-handed and right-handed.

Redundancy and Availability of the Functions

In the case where one of the devices is disturbed (mechanical or atmospheric disturbances in respect of resistive effects, electromagnetic disturbances or use of thick gloves in respect of capacitive effects), the operating principles being different between resistive and capacitive effects, the system can operate according to a single of the two modes and optionally in a degraded mode.

Three-Dimensional Management of the Touchscreen

To the extent that it is possible to identify several overlaid pressing planes, and that, on the resistive plane, the measurement of the load is possible, an axis perpendicular to the plane of the touchscreen is utilizable and makes it possible to manage or to simulate, for example, the controlled depression of a control member.

What is claimed is:

1. A touchscreen device comprising at least one multiplexed touchscreen, control electronics and acquisition and processing electronics, the touchscreen comprising:
a first rigid substrate comprising a plurality of conducting rows; and
a second flexible substrate comprising a plurality of conducting columns perpendicular to the said rows, the control electronics comprising a first multiplexer addressing the plurality of conducting rows, the acquisition and processing electronics comprising a second multiplexer addressing the plurality of conducting columns, wherein
the control electronics comprises a generator of a high-frequency voltage supplying the first multiplexer in such a way that each row is subjected to an input voltage, and
the acquisition and processing electronics comprises:
a synchronous demodulator operating at the same frequency as the high-frequency voltage generator and delivering a plurality of output voltages on each column; and
means of calculation, storage and checking making it possible to calculate the impedance existing between each output voltage and the input voltage, to store it, to simultaneously determine its resistive and capacitive component, to deduce therefrom the type of action of the user on the touchpad.

2. The touchscreen device according to claim 1, wherein the acquisition and processing electronics comprises first storage means making it possible to carry out a mapping of the values of the various impedances over the entirety of the touchscreen in the absence of the hand of a user in the vicinity of the touchscreen and second storage means making it possible to carry out a mapping of the variations of the values of the various impedances over the entirety of the touchscreen in the presence of the hand of a user in the vicinity of the touchscreen.

3. The touchscreen device according to claim 1, wherein the acquisition and processing electronics comprises means for analysing the impedance making it possible to calculate the resistive part and the capacitive part of the said impedance.

4. The touchscreen device according to claim 3, wherein the acquisition and processing electronics comprises securing or monitoring means comprising means for comparing the resistive part and the capacitive part of each impedance with a predetermined value so as to deduce therefrom a possible cutoff of the row or column corresponding to the said impedance.

5. The touchscreen device according to claim 3, wherein the acquisition and processing electronics comprises means for recognizing the stroking also called pull-down of the touchscreen by a user finger, said pull-down corresponding to a local increase in the said capacitive part of the impedance.

6. The touchscreen device according to claim 3, wherein the acquisition and processing electronics comprises means for recognizing the physical contact also called pull-up of the touchscreen by a user finger, said pull-up corresponding to a local decrease in the said resistive part of the impedance.

7. The touchscreen device according to claim 5, wherein the acquisition and processing electronics comprises means for calculating the respective barycentres of the various pull-downs.

8. The touchscreen device according to claim 7, wherein the acquisition and processing electronics comprises means for calculating the position of the user's hand on the basis of the position of the respective barycentres of the various pull-downs.

9. The touchscreen device according to claim 7, wherein the acquisition and processing electronics comprises means of determining on the basis of the position of the respective barycentres of the various pull-downs whether the user's hand is a right hand or a left hand.

10. The touchscreen device according to claim 6, wherein, in at least one zone of the touchscreen, the acquisition and processing electronics takes into account only the pull up function so as to create a virtual keyboard in the said zone.

11. The touchscreen device according to claim 5, wherein, in at least one zone of the touchscreen, the acquisition and processing electronics takes into account only the pull-down function so as to create a touch-sensitive surface of touch-pad type in the said zone.

12. A viewing device comprising at least one viewing screen and a touchscreen device according to claim 1.

13. The viewing device according to claim 12, wherein the device is an aircraft instrument panel viewing unit intended to be used separately or simultaneously by a pilot and a copilot.

14. The touchscreen device according to claim 6, wherein the acquisition and processing electronics comprises means for calculating the respective barycentres of the various pull-ups.

15. The touchscreen device according to claim 14, wherein the acquisition and processing electronics comprises means for calculating the position of the user's hand on the basis of the position of the respective barycentres of the various pull-ups.

16. The touchscreen device according to claim 14, wherein the acquisition and processing electronics comprises means of determining on the basis of the position of the respective barycentres of the various pull-ups whether the user's hand is a right hand or a left hand.
